(19) United States
(12) Patent Application Publication
(10) Pub. No.: US 2009/0022923 A1
(43) Pub. Date: Jan. 22, 2009

(54) Apparatus and Method for Providing an Information Recording System

(76) Inventor: Nathan R. Walkingshaw, Bountiful, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/174,527

(22) Filed: Jul. 16, 2008

Related U.S. Application Data
(60) Provisional application No. 60/950,270, filed on Jul. 17, 2007.

(51) Int. Cl. B32B 33/00

(52) U.S. Cl. 428/40.1

(57) ABSTRACT

Apparatuses and methods for providing an information recording system that enables a paramedic to record and transpose vital signs during an emergency are disclosed. The information recording system may include one or more printed decals which may be written on during a response to an emergency and may then be affixed to one or more pages of a corresponding run report. The printed decals may include vital sign categories with associated recording means such as fill-in-the-blank locations, checkboxes and numerical alternatives, such as for taking measurements. The printed decals may be affixed to more than one surface before finally being affixed into a corresponding run report. By affixing the printed decal into an associated run report the recorded information is thereby effectively transposed into the report entirely. The decal may be printed directly on surgical or other tape or may be originally affixed to a backing and provided thereon.

### CROSS-REFERENCE TO RELATED APPLICATIONS

This application claims the benefit of U.S. Provisional Application No. 60/950,270, filed Jul. 17, 2007.

### BACKGROUND OF THE INVENTION

1. Field of the Invention

The present invention relates to an information recording system, and more particularly to an apparatus and method for providing an information recording system that enables a paramedic to record and transpose vital signs during a response to an emergency.

2. Background and Related Art

Paramedics currently use a variety of devices to treat patients at the scene of an accident. When a paramedic arrives at the scene of an accident, the paramedic has a responsibility to record and later transpose the vital signs of an associated patient. Due to the emergency nature of accidents, paramedics are usually hurried and responsible for several tasks, making recording and transposing vital signs accurately and efficiently both very important and often difficult.

One method currently employed by paramedics to record vital signs is to stick a piece of surgical tape, primarily used to secure a dressing onto a wound, onto one of their legs or to some other location and to write the vital signs on the tape. After the patient is subsequently treated and loaded into an emergency transportation vehicle, the paramedic is required to complete a run report, or some equivalent, regarding the accident. A run report provides all of the available information relative to a patient, including their vital signs, such that the patient receives the appropriate medical treatment upon arriving at a treatment facility. Consequently, paramedics must transpose the vital sign information written on the surgical tape into the run report. The emergency context often results in information that is difficult to decipher or correctly label, thus making transposition difficult. Additionally, in some instances, the paramedics may be responsible for recording information for multiple patients, in which case it may be difficult later for the paramedic to determine which information pertains to which patient, and retaking of vital signs may be necessary.

Thus, while techniques currently exist that are used to record and transpose the vital signs of accident victims, challenges still exist, including problems with accuracy and efficiency. Accordingly, it would be an improvement in the art to augment or even replace current techniques with other techniques.

### BRIEF SUMMARY OF THE INVENTION

The present invention relates to an information recording system. In particular, the present invention relates to an apparatus and method for providing an information recording system that enables a paramedic to record and transpose vital signs during an emergency or during a response to an emergency.

Implementation of the present invention helps paramedics and other emergency responders or personnel to accurately and efficiently record and transpose a patient's vital signs in an emergency. In some implementations, the apparatus is a printed decal which may be written on and subsequently placed directly into an associated run report. Specifically, the printed decal includes categories and locations for recording relevant information regarding the condition of a patient during an emergency. After filling out the appropriate information, the decal may then be placed directly in an associated run report, thus eliminating the need to transpose the information.

In other implementations, surgical tape or other adhesive-backed tape or material may be provided with locations for the desired information printed directly on the surgical tape. Using a printed decal and placing the decal directly into the run report upon completion enables rapid and accurate recordation of vital sign information. Similarly, using surgical tape including categories and locations and placing the surgical tape directly into the run report upon completion also enables rapid and accurate recordation of vital sign information. Furthermore, using such implementations is straightforward for paramedics, as the printed decal/tape may be used in a manner very similar to the current practice of taking of informational notes on standard surgical tape.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a representative embodiment of a printed decal for recording vital signs in accordance with embodiments of the present invention;

FIG. 2 illustrates the representative embodiment of FIG. 1 without reference numerals for clarity;

FIG. 3 illustrates a representative embodiment for providing a plurality of printed decals on a strip of tape or backing; and

FIG. 4 illustrates a representative method for using a decal to record information.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention relate to an information recording system. In particular, the embodiments relate to apparatuses and methods for providing an information recording system that enables a paramedic to record and transpose vital signs during an emergency.

In the disclosure and in the claims, the term “run report” shall refer to a final report completed by a paramedic or other emergency personnel responding to the scene of an accident or other emergency regarding the details of the accident/emergency and the associated administered treatment. Additionally, in the disclosure and in the claims, the term “decal” shall refer to a material with an adhesive backing that is capable of being written on and applied to and removed from one or more surfaces.

In accordance with at least some embodiments of the present invention, an information recording system includes one or more printed decals that may be written on and affixed to one or more pages of a corresponding run report. The present invention may be described by the following examples.

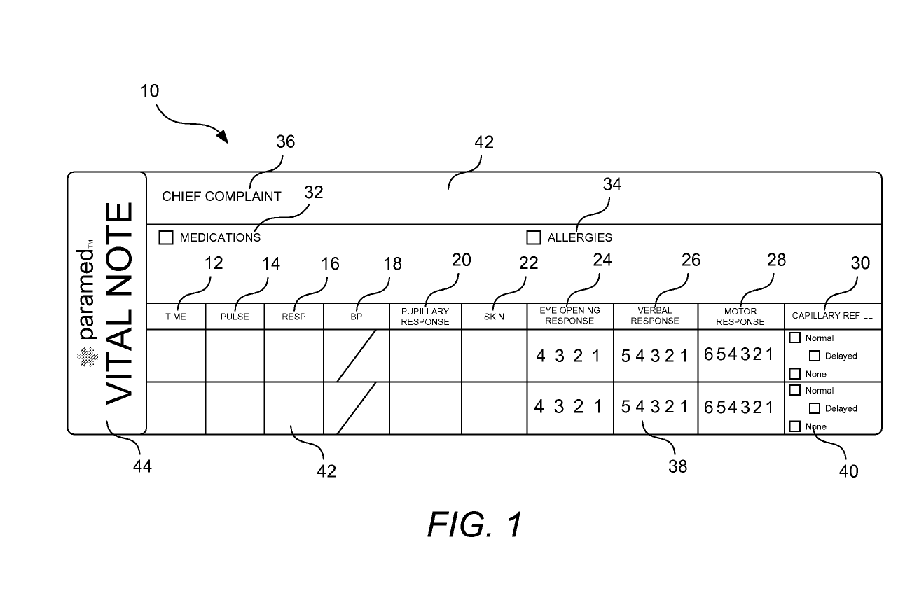

As a first example, a paramedic arrives at the scene of an accident involving one or more patients and engages in treating one or more patients. The paramedic retrieves a printed decal 10 for each individual patient affixing one or more decals to one of his/her legs. With reference to FIG. 1, the printed decal 10 may include categories such as time 12, pulse 14, respiratory function 16, blood pressure 18, papillary response 20, skin condition 22, eye opening response 24, verbal response 26, motor response 28, capillary refill 30, medications 32, allergies 34, and the chief complaint 36. The illustrated categories and spaces for providing information relating to those categories are merely illustrative and may be varied to suit a particular situation or need.

Moreover, also with reference to FIG. 1, each category on the printed decal 10 may include relevant recording means such as numerical measurement alternatives 38, checkboxes 40, and fill-in-the-blank locations 42. During the course of treatment, the paramedic may record the vital signs of each individual patient by circling the appropriate numerical alternative 38, checking the appropriate box 40 or filling in the appropriate blank location 42 on the printed decal 10. The printed decal 10 may subsequently be adhered directly to a corresponding blank location in the paramedic's run report. By recording the vital sign information on the decal 10 and then placing the decal 10 directly into the run report, the information is accurately and efficiently recorded such that the patient may receive the appropriate treatment at a subsequent facility. As may be appreciated and as is illustrated in FIG. 1, space may be provided to record information at multiple points in time for a single patient, and/or multiple printed decals 10 may be used in conjunction with a single patient. Some embodiments may be provided with a source identifier location 44 that may include an identification of the maker of the decal 10, that may include an identification of the paramedic service provider, or that may even include an identification of the paramedic or other responder.

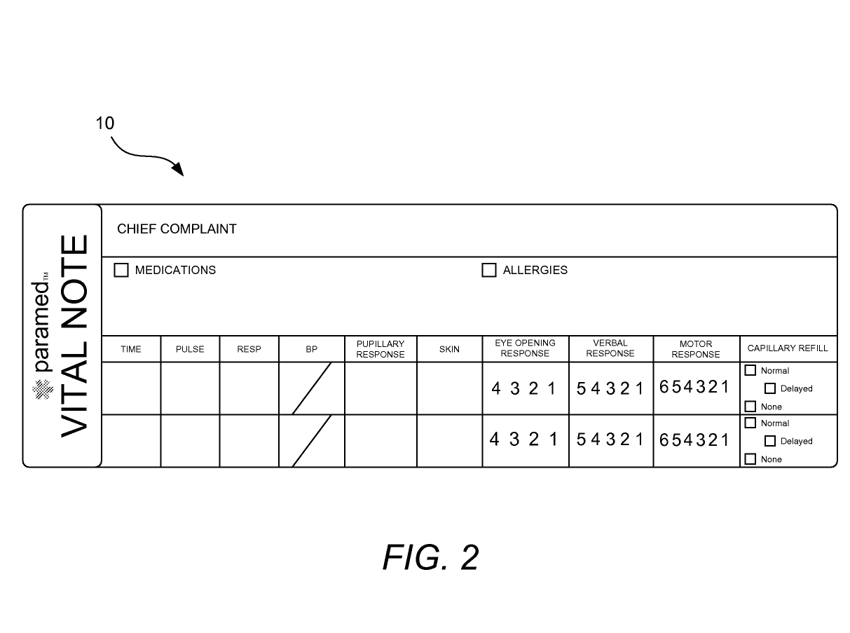

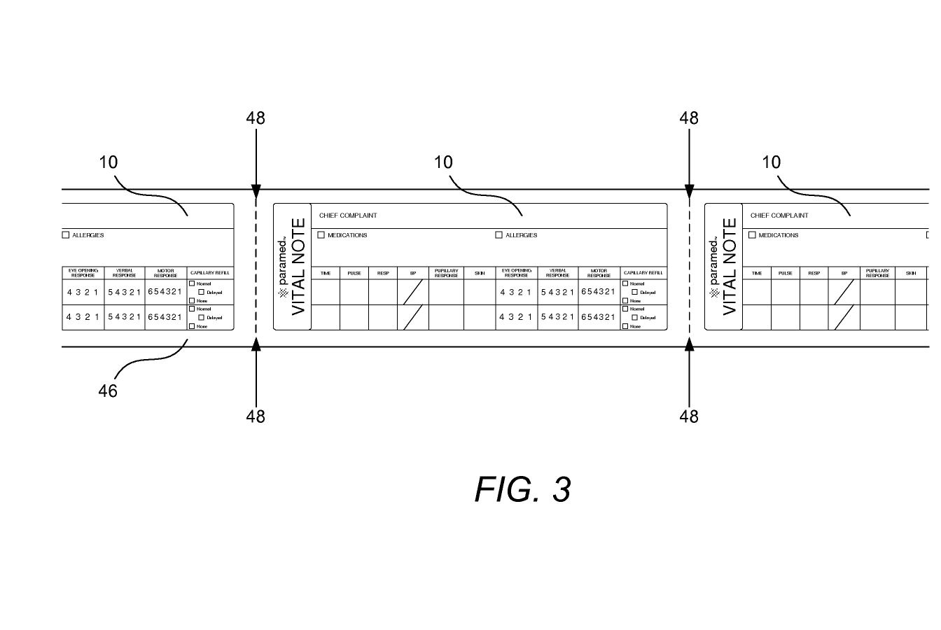

FIG. 2 shows the printed decal 10 of FIG. 1 without reference numerals to more clearly illustrate the features of the decal 10. FIG. 3 illustrates how multiple printed decals 10 may be provided attached to a dispensing backing material 46, or alternatively, how multiple printed decals 10 may be printed directly on an adhesive tape, such as surgical tape, which may then be torn or cut at locations 48 between decals 10. Even if tearing does not occur exactly at locations 46 during the emergency response, excess material (including, possibly, a portion of an excess decal 10, may be cut off, torn off, or otherwise removed during transfer of the decal 10 to the run report. The tape or backing material 46 and decals 10 may be stored on a roll or in any other fashion common with tapes and decals on backing materials. The space between and around the decals 10 illustrated in FIG. 3 (on the backing material 44 or between printed decals 10 on the tap) may be varied as desired to facilitate tearing or other access to the decals 10.

While FIGS. 1-3 show a decal 10 having a narrow dimension and a wide dimension, as well as a tape or backing material 46 wherein the decals 10 are disposed with their narrow dimensions adjacent each other, it is anticipated that other shapes of the decal 10 or dispositions of the decal 10 on the tape or backing material 46 may be utilized. For example, a substantially square decal 10 may be utilized, and may be oriented on the backing material 46 or tape in any desired orientation. Alternatively, a decal 10 having a narrow dimension and a wide dimension may be utilized but may be oriented orthogonally to the direction of the tape or backing material 46, so as to have their wide dimensions adjacent each other. Any such variation is embraced by the embodiments of the invention.

By way of a second example of use of the decal 10, a paramedic arrives at the scene of an accident or emergency involving one or more patients and engages in treating one or more patients. The paramedic retrieves a printed decal 10 for each individual patient, affixing one or more decals 10 to one of his/her legs. During the course of treating one or more patients and recording the associated vital signs on the printed decal, another need arises which requires the attention of the attending paramedic. Consequently, the paramedic's responsibilities may be assumed by other emergency personnel. By recording the vital sign information on the decal 10, the information may be transferred from one paramedic to another accurately and quickly during an emergency, simply by transferring the decal 10 from the leg of the first paramedic (or whatever other location used by the paramedic) to the leg (or other location) of the second paramedic.

In addition to the aspects illustrated in the preceding examples, the decal 10 may have additional information printed on it such that it may be useful as a measuring device or a conversion table among other things. The decal 10 itself may be made of any appropriate material with any desired properties, such as cloth, paper or vinyl. Furthermore, the decal 10 may be printed using the method of silk-screening, ink jet printing, direct press printing, or any other or equivalent method in the art, whether now known or realized in the future. Likewise, the decal 10 may vary in size, shape and color such that it is suited for efficient use in a variety of applications.

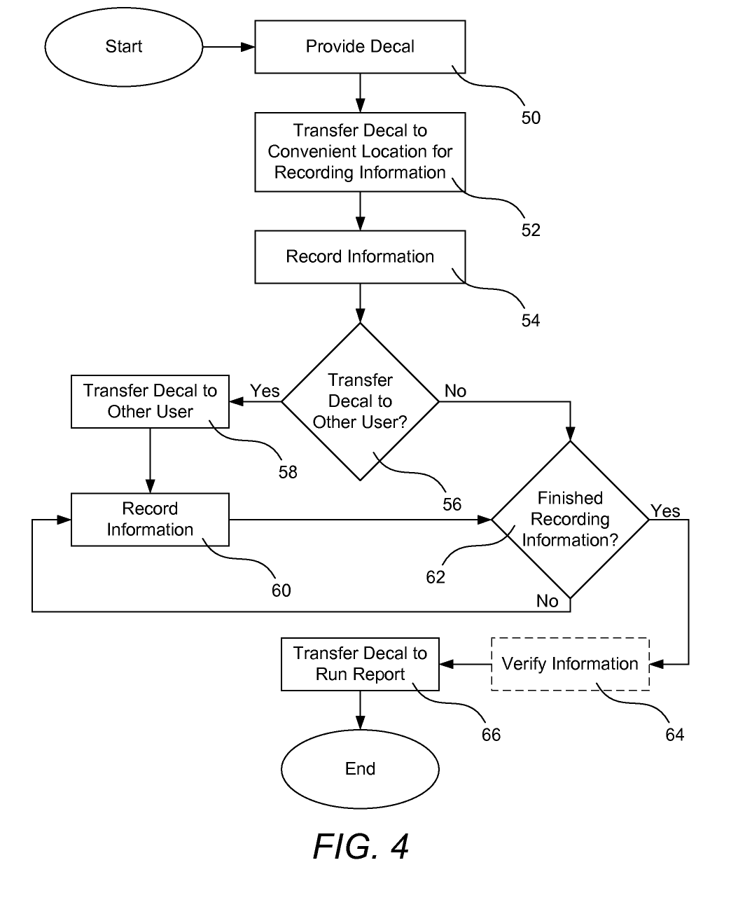

FIG. 4 illustrates a method for using the decal 10 to record information. The process may begin with providing a decal at step 50. The decal may be provided on a roll or in any other fashion, as described above, and may be provided as a printed decal removably affixed to backing material or may be directly printed on a roll of tape, such as on surgical-type tape. Execution may proceed to step 52, where the decal is transferred to a convenient location for recording information, such as to the leg or other location on or near an attending paramedic. Thereafter, information is recorded at step 54.

A determination is made at decision block 56 whether to transfer the decal to another user. This determination may be made, for example, when the attending paramedic is required to attend to another patient or to other duties, and another responder is to take over care of the paramedic's patient. If it is determined to transfer the decal to another user, execution proceeds to step 58, where the decal is transferred. It should be noted that transferring the decal may involve removing the decal from a location on one paramedic and placing it on a desired location on another paramedic or other responder. It should also be noted that if the decal is not affixed to the person or clothing of the first paramedic, but is affixed either to the patient or near the patient, the act of transferring the decal may only involve pointing out the location of the decal. Once the decal is transferred, execution may proceed to step 60, where additional information may be recorded.

After the information is recorded at step 60, or after it is determined at decision block 56 not to transfer the decal, execution proceeds to decision block 62, where a determination is made as to whether recording for a particular decal is finished. If not, execution may return to step 60 for recordation of additional information. If recordation is finished for a particular decal, execution may proceed to an optional step 64 of verifying the recorded information (which may include verifying legibility of the recorded information) and then to step 66 of transferring the decal to a run report or other permanent or semi-permanent location. For example, the step 66 of transferring the decal may include transferring the decal to the person of the patient, to be transported with the patient and be available for ready reference. Although the method of FIG. 4 has been illustrated with respect to a single decal for a single patient, it will be appreciated that variations on the illustrated method may be practiced with multiple decals for a single patient and/or with multiple decals for multiple patients.

While the apparatus and methods of the embodiments of the present invention discussed herein have proven to be particularly useful in the area of recording and transposing vital signs at the scene of an accident or other emergency, those skilled in the art may appreciate that the apparatus and methods may be used in a variety of different applications to yield an information recording system that enables recording and transposing information accurately and efficiently.

Thus, as discussed herein, the embodiments of the present invention embrace information recording systems. In particular, embodiments of the present invention relate to an apparatus and method for providing an information recording system that enables a paramedic to record and transpose vital signs during an emergency response. Aspects illustrated in one example are capable of implementation in other examples while remaining within the scope of the present invention.

The present invention may be embodied in other specific forms without departing from the spirit or essential characteristics of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A device for recording and transposing medical status information, comprising a decal having printing thereon configured to allow medical information to be quickly entered thereupon.

2. A device as recited in claim 1, wherein the decal further comprises:
a material having a front side capable of being written on; and
an adhesive backing affixed to a back side of the material and capable of reversibly bonding to a first surface and subsequently being removed and bonding to a second surface.

3. A device as recited in claim 2, wherein the decal comprises a portion of a continuous strip of printed tape.

4. A device as recited in claim 3, wherein the printed tape is surgical tape.

5. A device as recited in claim 3, wherein the continuous strip of printed tape comprises a plurality of adjacent decals.

6. A device as recited in claim 1, wherein the decal comprises a portion of a continuous strip of printed tape comprising a plurality of adjacent decals.

7. A device as recited in claim 1, wherein the decal comprises a material chosen from the group consisting of cloth, paper and vinyl.

8. A device as recited in claim 1, wherein the decal includes at least one vital sign category.

9. A device as recited in claim 8, wherein the at least one vital sign category includes a recording means chosen from the group consisting of fill-in-the-blank, checkbox, and numerical alternative.

10. A device as recited in claim 1, wherein the decal includes at least one means for recording at least one measurement.

11. A information recording system, comprising:
a printed decal configured to receive information recorded thereon; and
a run report page wherein the printed decal may be subsequently affixed.

12. An information recording system as recited in claim 11, wherein a plurality of printed decals corresponds to a plurality of run report pages wherein the plurality of printed decals may be subsequently affixed.

13. An information recording system as recited in claim 11, wherein the printed decal comprises a portion of a continuous strip of tape and wherein the continuous strip of tape comprises a plurality of printed decals.

14. A method for recording and transposing information comprising:
retrieving a printed decal;
recording information on the printed decal; and
transposing the recorded information to a corresponding run report by affixing the printed decal to the run report.

15. A method as recited in claim 14, further comprising transferring the printed decal to another location by affixing the at least one printed decal to the other location.

16. A method as recited in claim 14, further comprising tearing the printed decal from a continuous strip of printed decals printed on a roll of tape.

17. A method as recited in claim 14, further comprising reversibly transferring the printed decal to a convenient location for recording information.

18. A method as recited in claim 14, wherein recording information further comprises filling in blank locations on the at least one printed decal.

19. A method as recited in claim 14, wherein recording information further comprises checking an appropriate box on the at least one printed decal.

20. A method as recited in claim 14, wherein recording information further comprises denoting an appropriate numerical alternative on the at least one printed decal.
